(19) United States
(12) Patent Application Publication
(10) Pub. No.: US 2011/0261269 A1
(43) Pub. Date: Oct. 27, 2011

(54) APPARATUS AND METHOD FOR A LAPTOP TRACKPAD USING CELL PHONE DISPLAY

(75) Inventor: Farooq Khan, Allen, TX (US)

(73) Assignee: Samsung Electronics Co., Ltd., Suwon-si (KR)

(21) Appl. No.: 12/767,699

(22) Filed: Apr. 26, 2010

(51) Int. Cl. H04M 11/00; G06F 13/38; H04N 5/44; G06F 3/042; G06F 3/041; G06F 3/045

(52) U.S. Cl. 348/734; 345/173; 345/174; 455/556.2; 345/175; 710/63; 455/557; 455/566; 348/E05.096

(57) ABSTRACT

An input device is configured to act as a remote trackpad for an output device. The input device includes a touchscreen configured to display an image and receive either a single-touch or multi-touch user input. A communication interface configured to support wired or wireless communication links with an output device and send the user input to the output device.

### TECHNICAL FIELD OF THE INVENTION

The present application relates generally to a device with a touchscreen that can be used as a trackpad of a separate output device.

### BACKGROUND OF THE INVENTION

A trackpad, also referred to as a touchpad, is a pointing device consisting of a specialized surface that can translate the motion and position of a user's fingers to a relative position on a display screen. A touchpad is a common feature on laptop computers as a substitute for a computer mouse when surface space is scarce. Touchpads can also be found on personal digital assistants (PDAs) and some portable media players.

A multi-touch display system consists of a touch screen or a touchpad, as well as software that recognizes multiple simultaneous touch points, as opposed to the standard touch screen which recognizes only one touch point. This effect is achieved through a variety of means, including but not limited to heat, finger pressure, high capture rate cameras, infrared light, optic capture, tuned electromagnetic induction, ultrasonic receivers, transducer microphones, laser rangefinders, and shadow capture. Multi-touch displays can be found in several products such as the iPhone® from Apple®.

Laptops that replace the traditional touchpad with a liquid crystal display (LCD) panel that has embedded optical sensors have been recently introduced. A disadvantage to this approach is that a separate trackpad or LCD panel display is required to be embedded in each laptop. Therefore, there is a need in the art for an improved touchscreen input device.

### SUMMARY OF THE INVENTION

An input device capable of acting as a remote trackpad for an output device is provided. The input device includes a touchscreen that is configured to display an image and receive single-touch and multi-touch user input. The input device also includes a communication interface that is configured to support wired or wireless communication links with an output device and send the user input to the output device.

In an embodiment, the touchscreen receives user input by using at least one of a heat sensor, a pressure sensor, a high capture rate camera, an infrared light sensor, an optical sensor, a ultrasonic receivers, a tuned electromagnetic induction, a transducer microphone, a laser rangefinder, and a shadow capture.

The input device may be configured to slide into the output device and be directly coupled to the output device through the communication interface. The wired communication supported by the communication interface may be through the universal serial bus (USB) protocol. The wireless communication supported by the communication interface may be through Bluetooth, Wireless Fidelity (Wi-Fi), or visible light communication (VLC).

The input device of claim may be a mobile station, a personal digital assistant (PDA), or any device that is capable of communicating with other devices.

The input device may be a laptop computer, a desktop computer, a television, or an output display.

In an embodiment, the communication interface may be further configured to support bi-directional communication with the output device, and the touchscreen displays images based on data received from the output device.

In yet another embodiment, the communication interface may be further configured to support bi-directional communication with a second input device.

In some embodiments, a mobile device can act as a remote touchscreen for an output device. The mobile device includes a display screen having a touchscreen configured to display an image and receive single-touch and multi-touch user input. A transmitter is configured to transmit the user input to an output device over a wireless communication link. A communication port is configured to send the user input to the output device over a wired communication link.

The touchscreen may include optical sensors between pixels, and the optical sensors may be configured to sense objects placed on a surface of the touchscreen while the touchscreen displays an image.

In another embodiment, the mobile device may be configured to slide into a slot of the output device and be directly coupled to the output device through the communication port. The wired communication supported by the communication interface may be through universal serial bus (USB), and the wireless communication supported by the communication interface may be through Bluetooth, Wireless Fidelity (Wi-Fi), or visible light communication (VLC).

The output device may a laptop computer, a desktop computer, or any computing device that is capable of communicating with another device. In one embodiment, the output device may be a television, and the user input may correspond to controls for a menu screen on the television.

The transceiver and the communication port may be further configured to support bi-directional communication with the output device, wherein the touchscreen displays images that are based on data received from the output device.

In another embodiment, the transceiver and the communication port may be further configured to support bi-directional communication with a second mobile device. The second mobile device may also be configured to slide into a slot of the output device and be directly coupled to the output device through the communication port. The mobile device may be configured to communicate directly with the output device and the second mobile device.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an input device according to embodiments of the present invention;

FIG. 2 illustrates a communication link between an input device and a laptop according to an embodiment of the disclosure;

FIGS. 3A and 3B illustrate an input device that slides into a slot of an output device according to an embodiment of the disclosure; and

FIG. 4 illustrates two input devices communicating with each other where one of the input devices is inserted into a slot of an output device, according to an embodiment of the disclosure.

### DETAILED DESCRIPTION OF THE INVENTION

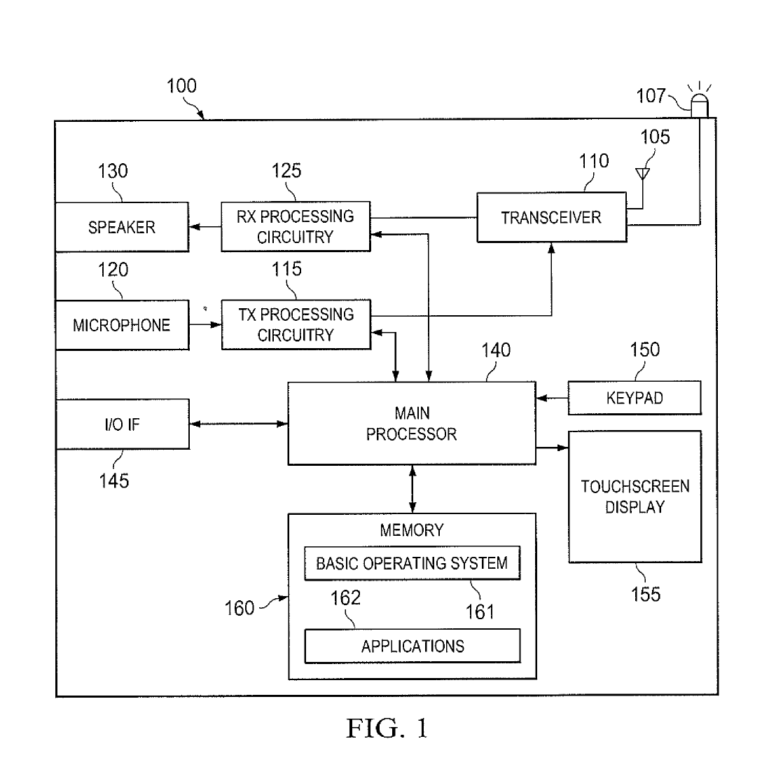

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device with communication capabilities.

FIG. 1 illustrates a device with a touchscreen that may be used as a trackpad for a separate output device, according to embodiments of the present disclosure. The embodiment of device 100 illustrated in FIG. 1 is for illustration only. Device 100 may be a mobile phone, personal digital assistant (PDA), laptop computer, tablet computer, or any other device that has communication capabilities. Other embodiments of the device 100 could be used without departing from the scope of this disclosure.

The device 100 comprises an antenna 105, a light source/sensor 107, a transceiver 110, transmit (TX) processing circuitry 115, microphone 120, and receive (RX) processing circuitry 125. Device 100 also comprises speaker 130, main processor 140, input/output (I/O) interface (IF) 145, keypad 150, touchscreen display 155, and memory 160. Memory 160 further comprises basic operating system (OS) program 161 and a plurality of applications 162.

Light source/sensor 107 is used to transmit and receive visible light communication (VLC) signals. Although the light source/sensor 107 is illustrated as a single component, a separate light source and light sensor may be used. Also, a single transceiver 110, RX processing circuitry 125, and TX processing circuitry 115 that accommodate both RF signals and visible light communication signals are shown in FIG. 1. In other embodiments, separate transceivers, RX processing circuitry, and TX processing circuitry may be used for RF signals and VLC signals. The present invention will now be described with regard to using RF signals.

Transceiver 110 receives from antenna 105 an incoming RF signal and down-converts the incoming RF signal to produce an intermediate frequency (IF) or a baseband signal. The IF or baseband signal is sent to receiver (RX) processing circuitry 125 that produces a processed baseband signal by filtering, decoding, and/or digitizing the baseband or IF signal. Receiver (RX) processing circuitry 125 transmits the processed baseband signal to speaker 130 (i.e., voice data) or to main processor 140 for further processing (e.g., web browsing).

Transmitter (TX) processing circuitry 115 receives analog or digital voice data from microphone 120 or other outgoing baseband data (e.g., web data, e-mail, interactive video game data) from main processor 140. Transmitter (TX) processing circuitry 115 encodes, multiplexes, and/or digitizes the outgoing baseband data to produce a processed baseband or IF signal. Radio frequency (RF) transceiver 110 receives the outgoing processed baseband or IF signal from transmitter (TX) processing circuitry 115. Radio frequency (RF) transceiver 110 up-converts the baseband or IF signal to a radio frequency (RF) signal that is transmitted via antenna 105.

With regard to VLC, the transceiver 110 receives data for transmission from the TX circuitry and transmits data signals and messages through the light source/sensor 107 using one or more light sources. Although only one light source is shown in light source/sensor 107, the transceiver 110 may be coupled to multiple light sources. The transceiver 110 receives VLC data signals and messages through the light source/sensor 107. The received data is processed by the RX processing circuitry. The light sensor is any component that is capable of detecting light such as, but not limited to, a photodiode (PD).

In some embodiments of the present disclosure, main processor 140 is a microprocessor or microcontroller. Memory 160 is coupled to main processor 140. According to some embodiments of the present disclosure, part of memory 160 comprises a random access memory (RAM) and another part of memory 160 comprises an Electrically Erasable Programmable Read-Only Memory (EEPROM).

Main processor 140 executes basic operating system (OS) program 161 stored in memory 160 in order to control the overall operation of device 100. In one such operation, main processor 140 controls the reception of forward channel signals and the transmission of reverse channel signals by radio frequency (RF) transceiver 110, receiver (RX) processing circuitry 125, and transmitter (TX) processing circuitry 115, in accordance with well-known principles.

Main processor 140 can move data into or out of memory 160, as required by an executing process. The main processor 140 can operate the plurality of applications 162 based on OS program 161 or in response to a signal received from BS 102. Main processor 140 is also coupled to I/O interface 145. I/O interface 145 provides device 100 with the ability to connect to other devices such as laptop computers and handheld computers. I/O interface 145 is the communication path between these accessories and main controller 140.

Main processor 140 is also coupled to keypad 150 and touchscreen display 155. The operator of device 100 uses keypad 150 to enter data into device 100. Touchscreen display includes an output component and an input component. The output component of touchscreen display 155 may be a liquid crystal display (LCD) screen or a light emitting diode (LED) screen. Alternate embodiments may use other types of displays. The input component of touchscreen display 155 is a touchpad that can detect single-touch (recognizes one touch point at a time) or multi-touch (recognizes multiple simultaneous touch points). Single- or multi-touch can be detected through a variety of means, including but not limited to: a heat sensor, a pressure sensor, a high capture rate camera, an infrared light sensor, an optical sensor, a ultrasonic receivers, a tuned electromagnetic induction, a transducer microphone, a laser rangefinder, and a shadow capture.

In one embodiment, the touchscreen display 155 packs optical sensors between the screen's pixels so it can both display an image and sense fingers or pens placed on its surface. The use of optical sensors instead of a touchscreen overlay on the small screen allows the LCD or LED panel to retain its brightness and also allows multiple fingers to be sensed simultaneously. In the most basic mode, the small screen serves as a conventional trackpad while allowing the small screen to display a menu with shortcuts to features like web page bookmarks, dictionaries, electronic books (e-books), photos, games, and such.

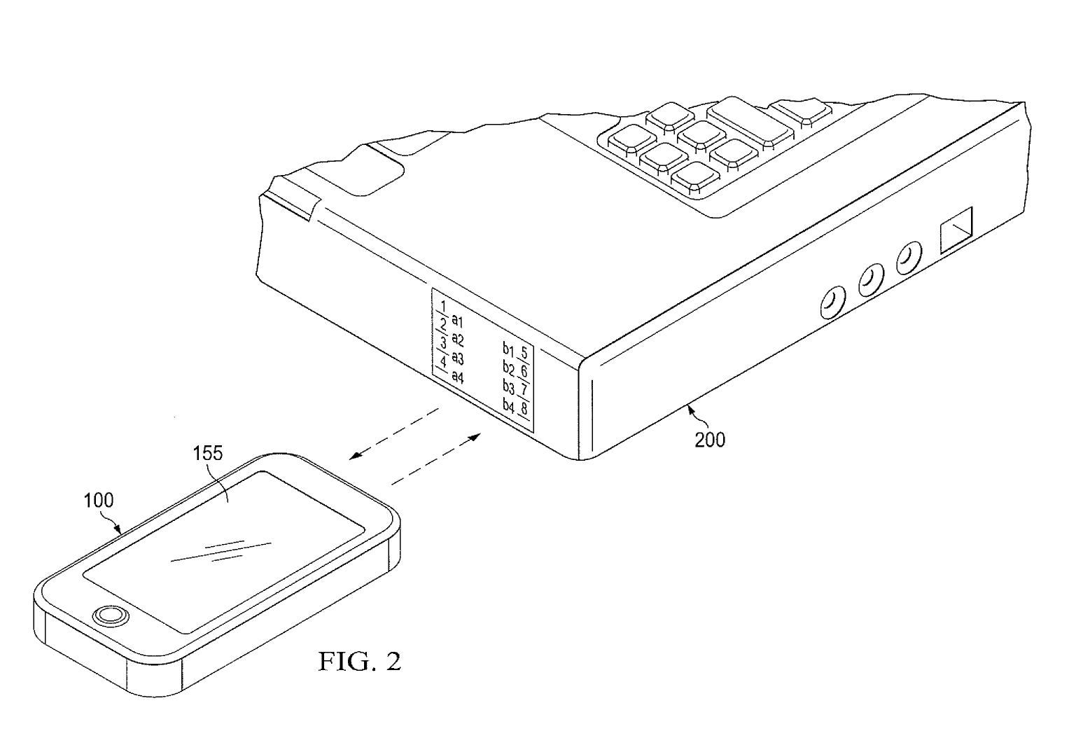

FIG. 2 illustrates a communication link between an input device and a laptop according to an embodiment of the disclosure. In the present invention, the touchscreen display 155 of the input device 100, which may be a cell phone or a PDA, is used as a laptop trackpad. The touchscreen display 155 can be a single-touch or multi-touch screen using any of the sensing mechanisms previously described. The communication between the cell phone and the laptop is enabled by a wired or a wireless communication link. An example of a wired communication link is universal serial bus (USB). Examples of wireless links are Bluetooth, wireless fidelity (Wi-Fi) and VLC. The wired or wireless communication link between the device 100 and the laptop computer 200 may be bi-directional. Although only laptop computers are illustrated in FIGS. 2-4 as establishing communication links with input device 100, any output device (such as a desktop computer, television, or a display monitor) having communication capabilities may be used to establish a connection with the input device 100.

In one embodiment, communication between, the input device 100 and the laptop computer 200 is enabled using a visible light communication (VLC) link. The VLC is specified in IEEE 802.15.7 standard and uses visible light spectrum for communication. A trackpad of the laptop computer 200 may consist of an LCD or LED panel with embedded optical sensors. Similarly, the touchscreen display 155 of the input device 100 employs LCD/LED display with photo detectors. Therefore, the trackpad of the laptop computer 200 and the input device 100 may act as both a transmitter and a receiver for bi-directional communication.

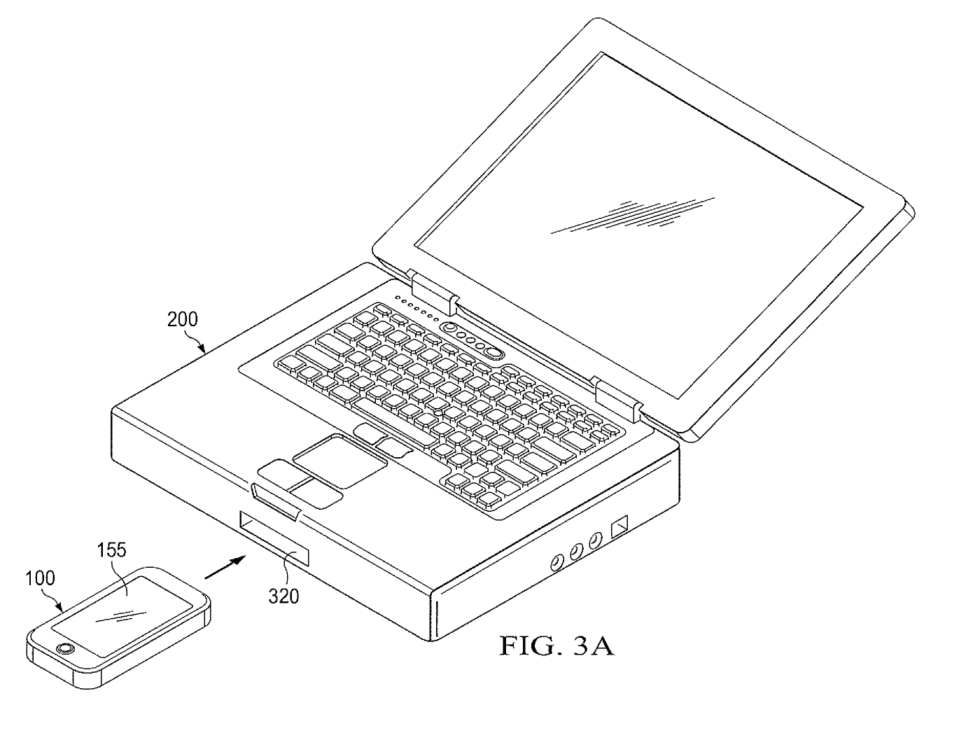

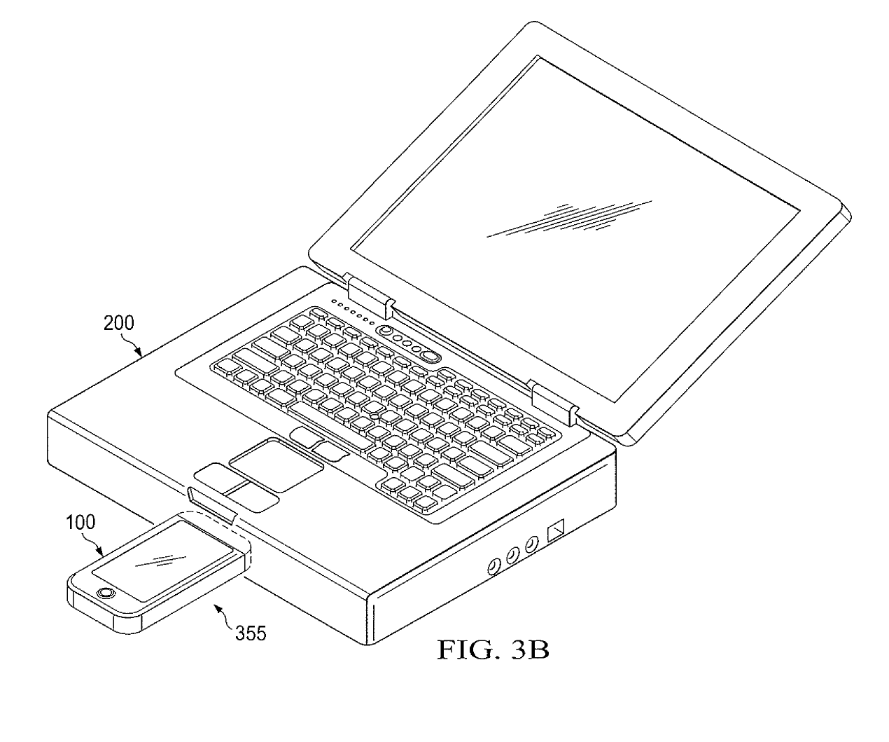

FIGS. 3A and 3B illustrate an input device that slides into a slot of an output device according to an embodiment of the disclosure. In FIG. 3A, laptop computer 200 has a slot 320, and the input device 100, having touchscreen 155, is separated from the laptop computer 200. In FIG. 3B, input device 100 slides into the slot 320 of the laptop computer 200. When connected, the input device 100 is connected to the laptop computer 200 through the I/O interface 145 to enable the touchscreen 155 of input device 100 to be used as a touchscreen/trackpad 355 for the laptop computer 200. The slot 320 in the laptop computer 200 provides housing for the input device 100 in such a way that when the input device is in place within the slot, it establishes a connection between the input device 100 and the laptop computer 200 for communication, power, or both. In one embodiment, the slot 320 and the input device 100 each provide a USB based connection.

In another embodiment, the touchscreen display 155 of input device 100 is used as a trackpad for a television (TV) screen or a external display. The input device communicates with the TV using a wireless communication link, such as Wi-Fi or Bluetooth. The user actions on the touchscreen 155 are displayed on the TV screen.

In yet another embodiment, the touchscreen display 155 of input device 100 is used as a trackpad for scrolling on a TV screen for selection of a widget from a multimedia service provided through the TV screen, such as weather, news, movies, photos, email, etc. Upon selecting a particular widget, the touchscreen display 155 may display a keyboard with which a user may interact to type text input.

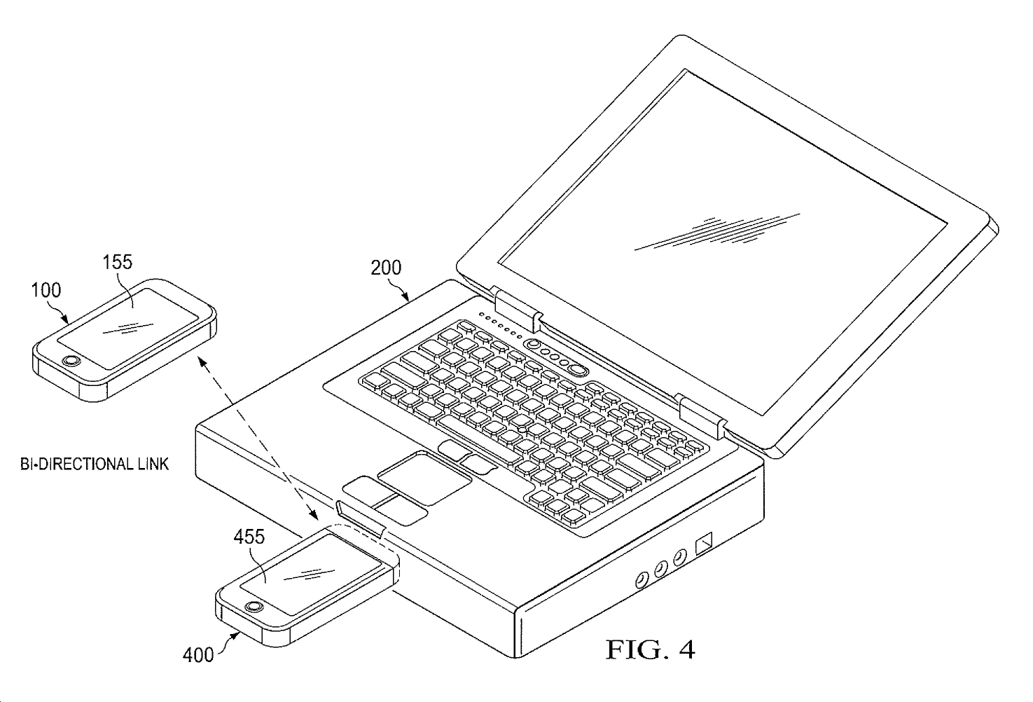

FIG. 4 illustrates two input devices communicating with each other where one of the input devices is inserted into a slot of an output device, according to an embodiment of the disclosure. Input device 100 may establish a wireless communication link with the laptop computer 200 or the input device 400. Input device 400 may be inserted into a slot of laptop computer 200 to communicate with the laptop computer 200 using a wired link such as USB. Alternatively, the input device 400 may also establish a wired link with the laptop computer 200 by simply using a connector wire. Input device 400 may also establish a wireless link with the input device 100. Therefore, each of input devices 100 and 400 and the laptop computer 200 can act as both a transmitter and a receiver for bi-directional communication.

In this configuration, a user may use the touchscreen 155 of the input device 100 as a touchscreen/trackpad of the laptop computer 200 or the input device 400 by directly transmitting the user input from input device 100 to the laptop computer 200. Alternatively, the user input on touchscreen 155 may be transmitted from the input device 100 to laptop computer 200 through the input device of 400. Or the user input on the touchscreen 155 may be transmitted from the input device 100 to the input device 400 through the laptop computer 200.

In one embodiment, touchscreen displays 155 and 455 of both input devices 100 and 400, respectively, may employ LCD/LED display with photo detectors to communicate with each other using a VLC link. Therefore, both devices can act as both a transmitter and a receiver for bi-directional communication.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An input device, comprising:
a touchscreen configured to display an image and receive single-touch and multi-touch user input; and
a communication interface configured to support wired and wireless communication links with an external device and send the user input to the external device.

2. The input device of claim 1, wherein the touchscreen receives user input by using at least one of a heat sensor, a pressure sensor, a high capture rate camera, an infrared light sensor, an optical sensor, a ultrasonic receivers, a tuned electromagnetic induction, a transducer microphone, a laser rangefinder, and a shadow capture.

3. The input device of claim 1, wherein the input device is configured to slide into the external device and be directly coupled to the external device through the communication interface.

4. The input device of claim 1, wherein the wired communication supported by the communication interface comprises a universal serial bus (USB).

5. The input device of claim 1, wherein the wireless communication supported by the communication interface comprises at least one of Bluetooth, Wireless Fidelity (Wi-Fi), and visible light communication (VLC).

6. The input device of claim 1, wherein the input device comprises at least one of a mobile station and a personal digital assistant (PDA).

7. The input device of claim 1, wherein the communication interface is further configured to support bi-directional communication with the external device, and wherein the touchscreen displays images based on data received from the external device.

8. The input device of claim 1, wherein the external device comprises at least one of a television, an external display, a laptop computer, and a desktop computer.

9. The input device of claim 1, wherein the external device is a second input device that comprises:
a second touchscreen configured to display an image and receive single-touch and multi-touch user input; and
a second communication interface configured to support wired and wireless communication links with an output device and send the user input to the output device.

10. The input device of claim 1, wherein the communication interface is further configured to support bi-directional communication with a second input device.

11. A mobile device, comprising:
a display screen comprising touchscreen configured to display an image and receive single-touch and multi-touch user input;
a transceiver configured to transmit the user input to an external device over a wireless communication link;
a communication port configured to send the user input to the external device over a wired communication link.

12. The mobile device of claim 11, wherein the touchscreen comprises optical sensors between pixels, the optical sensors configured to sense objects placed on a surface of the touchscreen while the touchscreen displays an image.

13. The mobile device of claim 11 wherein the mobile device is configured to slide into a slot of the external device and be directly coupled to the external device through the communication port.

14. The mobile device of claim 11, wherein the wired communication supported by the communication interface comprises a universal serial bus (USB), and wherein the wireless communication supported by the communication interface comprises at least one of Bluetooth, Wireless Fidelity (Wi-Fi), and visible light communication (VLC).

15. The mobile device of claim 11, wherein the external device is a laptop computer.

16. The mobile device of claim 11, wherein the external device is a television, and the user input corresponds to controls for a menu screen on the television.

17. The mobile device of claim 11, wherein the transceiver and the communication port are further configured to support bi-directional communication with the external device, and wherein the touchscreen displays images based on data received from the external device.

18. The mobile device of claim 11, wherein the transceiver and the communication port are further configured to support bi-directional communication with a second mobile device.

19. The mobile device of claim 18, wherein the second mobile device is configured to slide into a slot of the external device and be directly coupled to the external device through the communication port.

20. The mobile device of claim 19, wherein the mobile device is configured to communicate directly with the external device and the second mobile device.
